(19) United States
(12) Patent Application Publication
(10) Pub. No.: US 2009/0187911 A1
(43) Pub. Date: Jul. 23, 2009

(54) Computer device with reserved memory for priority applications

(76) Inventor: Patrice Martinez, Grenoble (FR)

Correspondence Address: BULL HN- MS B55 Russell W. Guenthner, 13430 Black Canyon Highway, Phoenix, AZ, 85029, US

(21) Appl. No.: 12/319,024

(22) Filed: Dec. 31, 2008

(30) Foreign Application Priority Data
Jan. 4, 2008 (FR) 08/00046

(51) Int. Cl. G06F 9/46; G06F 9/54

(52) U.S. Cl. 718/102; 719/312

(57) ABSTRACT

A computer device comprises a processor, a memory, and an operating system kernel. The kernel comprises instructions for managing the execution of processes and for allocating memory to such processes. The device is able to execute stored applications that can be broken down into processes. The device comprises a special instruction sequence able to create an inactive process with reservation of a certain quantity of memory, and an application launcher, arranged in such a manner as to remove the inactive process, thus freeing up the reserved memory, which is followed consecutively by commanding the launch of at least one particular application. The memory reserved beforehand is thus made quickly available for execution of the particular application.

### CROSS REFERENCE TO RELATED APPLICATIONS

This application Claims priority under 35 U.S.C. Section 119 to:
French Application Number: 08/00046
Country: FR
Holder: Bull SAS
Title:
   Dispositif informatique a memoire reserve pour des applications proritaires.
Inventors: Patrice Martinez
Filing Date: Jan. 4, 2008

and which is hereby incorporated by reference.

### CROSS REFERENCE TO RELATED APPLICATIONS

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

The invention relates to a computer device, and more particularly a computer device of the type comprising at least one processor, a memory, and an operating system kernel. There are many devices of this type, such as, for example, computers with a single processor or several processors, and computer clusters, comprising a plurality of computers. The devices of this type are usually arranged in such a manner as to execute computer applications, which are typically stored on data media such as hard disks, each computer application being broken down into one or more processes being executed separately.

The operating system kernel generally comprises instructions for managing the execution of the processes by the processors and the allocation of memory to said processes with memory for a processor usually including memory in the form of random access memory. Data or program code stored in the random access memory of the processor is typically faster to access than data or program code stored on hard disks,

In any computer system or computer device, the quantity of random access memory is always limited by the hardware configuration of the device.

When the execution of a process, or an application, requires a greater quantity of memory than the quantity of physical memory available at the moment of process execution, the kernel of the operating system is generally arranged in such a manner as to unload a part of the random access memory currently in use, by copying the content of this part onto a different data storage space, classically the hard disk of the computer device. This operation, designated by the term “swapping”, frees up random access memory for the execution of the process or the application.

The performance differences of the current data storage media, such as the access time and the read/write speeds, are such that the swapping operation is fairly slow. And therefore this swapping operation may slow down the execution of the process or the application. For some particular applications, such a slowing down in their execution is unacceptable. Thus there is a need, to avoid slowing down execution of an application or process, to ensure that a sufficient quantity of random access memory is available for the execution of certain processes or applications without the necessity or potential necessity for a swapping operation.

### BRIEF SUMMARY OF THE INVENTION

The invention aims to improve the above situation by proposing a computer device of the type comprising a processor, a memory, and an operating system kernel. The kernel includes routines and instructions to manage the execution of processes and allocation of memory to these processes. The computer device is able to execute stored program applications, which are typically broken down into processes. Each process includes as a part of its instruction code the invocation of a special routine or instruction sequence which is able to create an inactive process with reservation of a certain quantity of memory. The computer device further includes an application launcher, arranged in such a manner as to remove the inactive process, by freeing up the reserved memory, and, consecutively, by commanding the launch of at least one particular application, such that the memory reserved beforehand is made available for use by the particular application.

The invention also provides a method for executing a particular application among a plurality of applications stored on a computer device, comprising the following start-up steps of the computer device that include the creation of an inactive process with reservation of a certain quantity of memory, the removal of said inactive process, the launch of at least the particular application, following the removal step, such that the memory reserved beforehand is now made available for the particular application. There is no requirement for a relationship between the inactive process that provides reservation for a certain quantity of memory and the particular application which may use the reserved area of memory. The amount of memory reserved can be set at known or predetermined amounts of memory with expectation of later need for these amounts, or, reserved areas of memory can be combined to provide for one particular application.

There may in some cases however be advantage to having an inactive process related to a particular application in that the area of reserved memory could then be reserved at just the right size for later use by a particular application. This would allow removal of only one inactive process to satisfy a need for memory by a particular application, rather than possibly several inactive processes which might not have reserved precisely the needed amount of memory.

Hence, with application of these or similar embodiments of the invention, it becomes possible to reserve a certain quantity of memory for a particular application that may need to be run with good start-up performance, this quantity of memory not being able to be used by other applications, and always ready for use when needed for the particular application. An efficient start-up of an execution of the application in question can therefore be achieved at any moment.

Other characteristics and advantages of the invention will emerge on examination of the detailed description hereafter, of the Figures of the Drawing and of the example code herein.

### BRIEF DESCRIPTION OF THE SEVERAL VIEWS OF THE DRAWING

In accordance with the teachings of the present invention an illustrated embodiment of the invention includes the following.

FIG. 1 diagrammatically shows a computer device constructed according to the invention.

FIG. 2 functionally shows the structure of a data storage medium for the device of FIG. 1.

FIG. 3 is a flowchart illustrating the operation of an application launcher for the device of FIG. 1 according to the invention.

Example 1 (program code) shown further below illustrates exemplary computer code for realizing a special instruction sequence as intended for the application launcher.

The drawing and example code in Example 1 shown further below can be used not only for completing the invention, but also help in its definition, if necessary.

### DETAILED DESCRIPTION OF THE INVENTION

The invention will be better understood by means of the following description, given only as an example and in reference to the attached drawings.

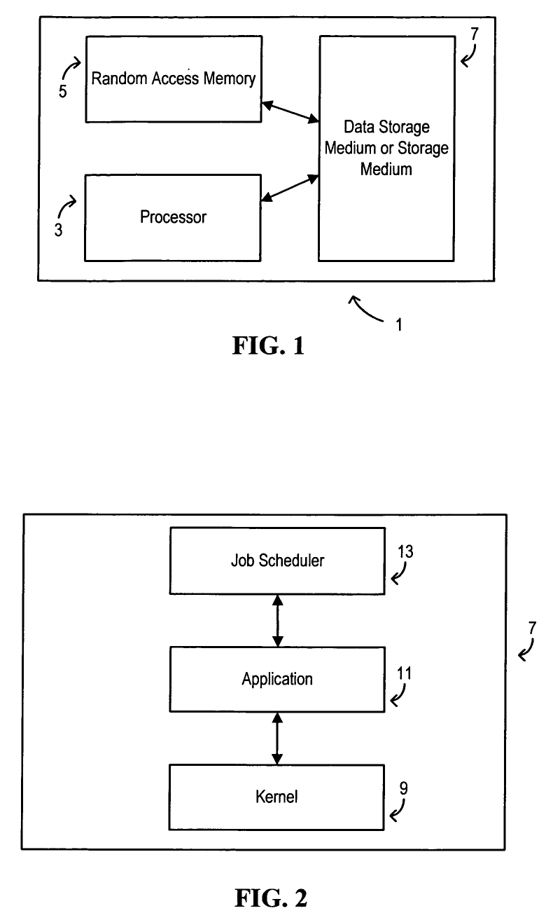

FIG. 1 functionally shows the structure of a computer device 1 constructed according to the present invention. The computer device 1 comprises at least one processor 3, a random access memory 5 and a data storage medium 7 interconnected for interacting mutually for the execution of an operating system comprising a kernel 9, shown in FIG. 2. For example, this operating system may be constructed in accordance with the Unix standard or its successors. This includes an operating system of the Linux type, which may further comprise a kernel of version 2.4 or 2.6, obtained for example from the REDHAT distribution RHEL3, RHEL4 or RHEL5. which are well known in the art. Other versions of Unix or Linux or their successors or predecessors may provide the necessary functionality to support the apparatus and/or method of the invention.

In a particular illustrated embodiment, the computer device 1 takes the form of a cluster composed of a plurality of computers, in particular operating as servers, each of the computers of the cluster being able to comprise one or more processors and the random access memory 5. In FIG. 1, all of the processors of the cluster are represented by the single processor 3, and all of the random access memory of the cluster is represented by the random access memory 5.

The memory, or random access memory, may be associated physically near the processors, or it may be located centrally and accessible by all processors. The memory may be hierarchical with different speeds of memory at different levels of the hierarchy. Other variations and arrangements of memory are known in the state of the art, or could be devised in response to special needs by one skilled in the art.

As a general rule, random access memory (memory) is typically significantly faster (10× to 100× or even more) than access time to storage on a hard disk. Caching of data on a hard disk may speed typical accesses to data on the hard disk, but when large blocks of data are exchanged on hard disk, the caching is less effective, or completely ineffective. Likewise, caching of Random Access Memory within a processor may speed the apparent access to data which is viewed by the programmer to be “in memory”. These access time phenomena and ratios of comparative access time to different levels of a data storage hierarchy are well known or can be observed or measured by one knowledgeable in the art.

In FIG. 2, the data storage medium 7 includes storage of an operating system whose kernel 9 comprises a software component or part corresponding to a scheduling device, or “scheduler” (not shown). The scheduler is arranged in a well known manner to organize the access of the different processes being executed on the computer device 1 to the resources of the device 1. The scheduler is arranged in a well known manners of the art to allocate to each process, a portion of the resources of the processor 3 and a portion of the random access memory 5 required for process execution.

For example, the scheduler can be arranged in such a manner as to direct each process to execute on a particular processor or on a particular computer, in the case of a machine with several processors or a cluster of machines, respectively. Depending on the hierarchy of storage, other schemes for optimizing performance may make direction of a process to run on a specific board, or in a specific cabinet may be beneficial to performance. Again, these optimizations can be determined by one knowledgeable in the art.

The storage medium 7 is arranged to store one or more applications 11, with which the operating system is capable of interacting with as required for execution.

An application may be broken down into a plurality of processes, which are capable of being processed by the scheduler of the kernel 9 for execution by the computer device 1, including the memory 5 and the processor 3.

The storage medium 7 is arranged also for storing a scheduling program, or scheduler, of tasks 13, that can also be designated by such terms as “job scheduler” or “batch scheduler”. The scheduler is typically a part of the operating system, or a process performed frequently by the operating system.

The job scheduler 13 is arranged in such a manner as to organize the launch of at least some of the plurality of applications 11 stored on the storage medium 7. In particular, the job scheduler 13 is arranged in such a manner as to launch, for the execution of each application program, a parent process, each application itself being generally broken down into several child processes. According to the teachings of the present invention, the storage medium 7 further stores a special instruction or instruction sequence, coded in such a manner as to create an inactive process with reservation of a chosen quantity of random access memory 5.

The quantity of random access memory 5 is a parameter of this instruction sequence, and is preferably chosen according to the quantity of memory required, or at least desirable, for the execution of a particular application, considered to have priority, among the applications 11.

In the illustrated embodiment, the special instruction sequence uses the Unix commands “malloc” and “mlock”. The “malloc” operation allocates an amount of memory as requested by a calling program (or returns an error if the operating system cannot fulfill the request). The “mlock” program locks a requested amount of memory with the requested amount defined by a calling program at a location also specified by the calling program. The “mlock” disables paging for the memory in the range starting at “addr” with length “len” bytes. All pages which contain a part of the specified memory range are guaranteed be resident in RAM when the mlock system call returns successfully and they are guaranteed to stay in RAM until the pages are unlocked by other defined calls to the operating system such as munlock or until the process terminates or starts another program with a call to a routine such as “exec”. The functionality of Linux and/or Unix routines such as mlock, munlock, exec, and malloc are well known to computer programmers skilled in the art of C programming, system programming, real time programming or other programming disciplines of this nature.

The operating system is arranged in such a manner that the special routine or instruction sequence is executed as the computer device 1 is started up, to ensure that a sufficient quantity of memory is available for the reservation. Here, the special routine or instruction sequence is arranged as a part or a form of a process being executed in the background, or “daemon” in Unix language, loaded at the start-up of the computer device 1.

The illustrated embodiment also uses the special instruction sequence (routine) provided as part of the operating system called “malloc”. The “malloc” routine

Example 1, below, sets forth, for illustrative purposes only, the source code of a program that is able to create an inactive process consuming and locking (“main” function) a required quantity of memory, once such source code is compiled and executed.

EXAMPLE 1.
#include <stdlib.h>
include <stdio.h>
#include <signal.h>
include <string.h>
#include <sys/mman.h>
#define Kb *1024 10
#define Mb Kb*1024
#define Gb Mb*1024
void usage (char *s)
{ fprintf (stderr, “%s <size in Gb to lock>\n”,s);

(void) exit(−1);

}
int main (int argc, char **argv)
{ unsigned long len;

| char * addr; | | |
|---|---|---|
| if (argc < 2 ) usage (argv[0]); | | |
| len = (int) (atof(argv[1])Gb); | | |
| /* allocate memory of length “len” and | | */ |
| /* | return the base address of the allocated memory | */ |

addr = malloc(len);
signal (SIGCHLD, SIG_IGN);
switch (fork( )) {

case 0 :

| /* lock allocated memory of length “len” | | */ |
|---|---|---|
| /* | at address “adr” | */ |

if (mlock( addr, len)) {

perror(“mlock”);
exit (−2) ;

| } | | |
|---|---|---|
| /* wait | | */ |
| /* | (saving the allocated memory space | */ |
| /* | for later use by a particular application) | */ |

while (1) sleep (3600);
break;

case −1 : exit (−1);
default : exit ( 0) ;

}

}

This program (Example 1 just above) can be used as a “daemon”. The term “daemon” relates more particularly to Unix systems. The special routine or instruction sequence as part of the daemon could, however, be implemented in the form of a service in environments of the Microsoft Windows type (registered commercial name), or in other similar form in the case of different operating systems.

In variants of illustrated embodiment, the special routine or instruction sequence can be launched by means of the job scheduler 13.

As soon as the computer device 1 is started up, a quantity of memory 5, which it is possible to select, is reserved and locked by the said inactive process created in response to the special routine or instruction sequence. Once reserved, none of the applications 11 can then use this quantity of memory 5. In particular, this quantity of memory 5 cannot undergo a “swapping” operation, said operation moreover being locked. The job scheduler 13 is arranged in such a manner to remove the said inactive process and, consecutively, to command the launch of said particular application.

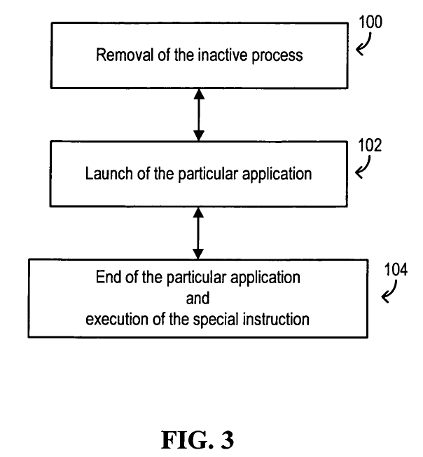

FIG. 3 illustrates the operation of the job scheduler 13. In a step 100, a special command is executed for removing the inactive process. For example, this special command can be implemented through the use of a Unix command “kill”. The removal of the inactive process frees up the reserved quantity of random access memory 5.

In a step 102, following step 100, the particular application is launched by means of a call instruction sequence. The memory freed up is made available for the particular application.

In a step 104, the end of the particular application is consecutively (without break) followed by, a new execution of the special routine or instruction sequence. It is important that the steps 100 and 102 are seen by the scheduler of the kernel 9 as two jobs immediately succeeding each other, without other intervening memory allocation or swapping operations by the operating system which might interfere. This ensures that the reserved quantity of random access memory 5 cannot be assigned to a different process.

When the job scheduler 13 is arranged in such a manner to implement the step 104, said scheduler functions as an application finisher.

When the job scheduler 13 is arranged in such a manner as to implement the step 100 and 102, said scheduler functions as an application launcher.

In the particular illustrated embodiment, the job scheduler 13 used is of the type marketed under the name LSF (Load Sharing Facility) by the Platform company (registered name) which has a website at www.platform.com with this particular product described there at http://www.platform.com/Products/platform-lsf from which the following description is taken:
“Platform LSF, the flagship product in the Platform Accelerate Suite, allows you to manage and accelerate batch workload processing for mission-critical compute- and data-intensive application workload. With Platform LSF you can intelligently schedule and guarantee the completion of batch workload across your distributed, virtualized, High Performance Computing (HPC) environment.”

This job scheduler has a configuration file in which each launch job of an application can be defined. For each launch job of an application, the instructions to execute before the launch of the parent process of the application in question are contained in an initial part of the configuration file.

The launch context of the parent process of the application in question is defined in a main part of the configuration file.

The context in which the processes of the application in question terminate is defined in a terminal part of the configuration file.

The job corresponding to the launch of said particular application is configured as follows:
the initial part comprises an execution routine or instruction sequence containing the said special command for removing the inactive process, and
the terminal part comprises an execution routine or instruction sequence containing the special routine or instruction sequence intended for the creation of the inactive process.

The device according to the teachings of the present invention enables a quantity of memory to be reserved for a particular application, to the exclusion of any other application. Such a particular application can be qualified as having priority over any other such application. By preventing any “swapping” operation on the quantity of reserved memory, a rapid start-up and thus good execution performances are guaranteed for the particular application. However, said memory being unlocked and freed up just before the launch of the particular application, said application can also use a “swapping” operation, if its execution requires it.

The device according to the teachings of the present invention may provide several special instructions, intended to reserve several quantities of random access memory, for example for several priority applications, or for different operating states of a same priority application.

Also, the job scheduler 13 can be arranged in such a manner as to allocate the same quantity of memory to several different applications, for example when these applications are not intended to be executed simultaneously.

In the case of devices having a non-uniform memory topology (called “NUMA”, for “Non Uniform Memory Access”), it is advantageous to provide a special memory reservation routine or instruction sequence for each processor or for each “node”, a “node” designating a set comprising a random access memory and a processor on a same bus.

The invention proposes an efficient solution to the problem of the availability of memory for a priority application. This solution is particularly flexible. It is devoid of any modification of the information system, and offers functionalities that do not exist in current operating systems, particularly of the Unix type.

In the description above, reference was made to the start-up of the operating system. The start-up of an operating system can cover noticeably different technical aspects according to the operating system in question. This start-up relates in practice to a complex set of operations executed by the device, prior to the operating, or working, phase itself. It is important that the execution of the special routine or instruction sequence takes place as early on as possible in such manner as to have a sufficient quantity of memory to reserve the required quantity of memory for the particular application. This execution can therefore be carried out at different stages of the start-up process of the operating system, at the loading of the kernel 9, or even following the start-up of this kernel and prior to the loading of other applications.

The invention can be implemented as a process for executing a particular application among a plurality of applications stored on a computer device.

The invention is not limited to the illustrated embodiments described above, which are only for illustrative purposes, but encompasses all the variants that those skilled in the art can envision.

Having now described the preferred embodiments of the invention, it will become apparent to one of skill in the arts that other embodiments incorporating the concepts may be used. It is felt, therefore, that these embodiments should not be limited to the disclosed embodiments but rather should be limited only by the spirit and scope of the following claims.

What is claimed is:

1. A computer device comprising a processor, a memory, and an operating system kernel, the kernel comprising instructions for managing execution of processes and the allocation of quantities of the memory to these processes, the device being able to execute stored applications, that can be broken down into processes, the computer device comprising:
a) a special instruction sequence able to create an inactive process along with reserving a certain quantity of the memory, and
b) an application launcher, operative to remove the inactive process, by freeing up the certain quantity of reserved memory, and then, consecutively, causing a launch of at least one particular application, so that the certain quantity of previously reserved memory is now made available to one particular application.

2. A device according to claim 1, wherein the application launcher is arranged in such a manner as to command the execution of a removal instruction sequence to remove the inactive process then, consecutively, a call instruction sequence which invokes the particular application.

3. A device according to claim 1, further comprising a job scheduling device arranged in such a manner as to implement the application launcher.

4. A device according to claim 2, further comprising a job scheduling device arranged in such a manner as to implement the application launcher.

5. A device according to claim 1, further comprising an application finisher arranged in such a manner as to command the execution of the special instruction sequence, following the stopping of the particular application.

6. A device according to claim 5, wherein a job scheduling device is arranged in such a manner as to implement the application finisher.

7. A device according to claim 1, wherein the special instruction sequence comprises a memory reservation command for accepting a value of quantity of memory to reserve as a parameter.

8. A device according to claim 1, wherein the special instruction sequence is executed at the start-up of the operating system.

9. A device according to claim 4, wherein the special instruction sequence is executed at the start-up of the operating system.

10. A method for executing a particular application among a plurality of applications stored on a computer device that includes a processor, a memory, and an operating system kernel, the method comprising the following steps:
a) creating an inactive process along with reservation of a certain quantity of the memory by executing a special instruction sequence;
b) removing said inactive process, and,
c) launching the particular application such that the certain quantity of the memory reserved in step a) is made available to the particular application.

11. A method according to claim 10, wherein:
the step b) comprises the execution of a removal instruction sequence which removes the inactive process; and,
the step c) comprises the execution of a call instruction sequence which launches the particular application.

12. A method according to claim 10, further comprising the following steps:
d) stopping the particular application; and,
e) commanding the execution of the special instruction sequence following the step d).

13. A method according to claim 11, further comprising the following steps:
d) stopping the particular application; and,
e) commanding the execution of the special instruction sequence, following the step d).

14. A method according to claim 10, wherein the special instruction sequence of step a) comprises the execution of a memory reservation command with a value of quantity of memory to reserve as a parameter.

15. A method according to claim 10, comprising executing a start-up step of the operating system prior to the execution of step a).
